(19) United States
(12) Patent Application Publication
(10) Pub. No.: US 2011/0233204 A1
(43) Pub. Date: Sep. 29, 2011

(54) Microwave Kitchen Aid Tool (MKAT)

(76) Inventors: Fordyce B. Townes, II, (US); Katrina Dudley, (US)

(21) Appl. No.: 12/748,431

(22) Filed: Mar. 28, 2010

(51) Int. Cl. H05B 6/64

(52) U.S. Cl. 219/762

(57) ABSTRACT

A Injection molded part that is design to ride on any standard, or large microwave turntable. This unit will allow the user to double the capacity of your current microwave. The benefit of using the unit will decrease the time in heating, or reheating ref in your standard, or large microwave. This will in turn save time, energy, and money in the life time use of the unit.

### CROSS-REFERENCE TO RELATED APPLICATION

Ser. No. 61/167,132

### FEDERALLY SPONSORED RESEARCH

None

### SEQUENCE LISTING

None

### BACKGROUND

This embodiment is design for microwave accessories industry. The embodiment was developed to solve the problem of how to heat two items, at the same time, in a standard to large microwave. The method of heating today only takes advantage of the one rotating tray we use today in our standard microwaves. We have design a embodiment that will allow a lower platform, and upper platform. This give the consumer the ability to heat, or reheat twice the items, and in effect doubling the capacity of the current microwave.

### SUMMARY

In accordance with one embodiment a high temperature thermo plastic design to provide a secondary platform for heating, or reheating items in a standard to large microwave. This event happen everyday in every household around the world. We have provided a embodiment that is not currently present in today's market. This embodiment should change the way we use microwave to heat, and reheat food items. The following drawing should give a clear vision of how the embodiment will function in your standard, or large microwave.

### DRAWING

FIG. 1 is a front view of the embodiment inside a standard microwave with general notes.

FIG. 2 is a elevation view showing the attachment of the embodiment to ref. 1 by inserting into ref. 2.

FIG. 3 is a prospective view of the entire embodiment with all reference parts call our with associated numbers.

FIG. 4 is a elevation view showing the embodiment with two standard kitchen plates each stack on the embodiment. We have also included ref. 10 which is design as a cover for the entire embodiment.

FIG. 5 shows a perspective view of the embodiment with ref 8 as related to ref. 10

FIG. 6 shows perspective view of embodiment with ref. 8 on both platform inside a standard microwave.

FIG. 7 is a plan view of embodiment ref. 1 with dimension and section call outs. All materials and designs utilizes the injection mold process with any approved high temperature thermo dynamic materials design to be used in the microwave industry.

FIG. 8 is the cross section of embodiment ref. 1 with dimensions.

FIG. 9 shows elevation view of lower leg ref. 3 with dimension and sections callout.

FIG. 10 is cross section of ref. 3 showing dimension and detail callouts.

FIG. 11 is the detail for ref. 3 with dimensions.

FIG. 12 is the detail 2 for embodiment ref. 1 showing dimensions and cross section.

FIG. 13 is detail 1 from embodiment ref. 1 showing dimension and details.

FIG. 14 is a assembly of all component diagramming how they connect together. All reference number are shown.

FIG. 15 is the main assembly in plan view showing all component and dimension and sectional call outs.

FIG. 16 is a cross section of embodiment ref. 4 and 6 with dimensions.

FIG. 17 is ref. 5 showing dimensions.

FIG. 18 is side view of ref. 5.

FIG. 19 is a plan view of ref. 7 with dimension.

FIG. 20 shows elevation view of ref. 7 with dimensions

FIG. 21 is a elevation view of ref. 10 with dimensions.

FIG. 22 shows ref. 10 in plan view with dimension.

FIG. 23 is a cross section of ref. 4 with dimensions.

FIG. 24 is a cross section of ref. 6

### DETAIL DESCRIPTION

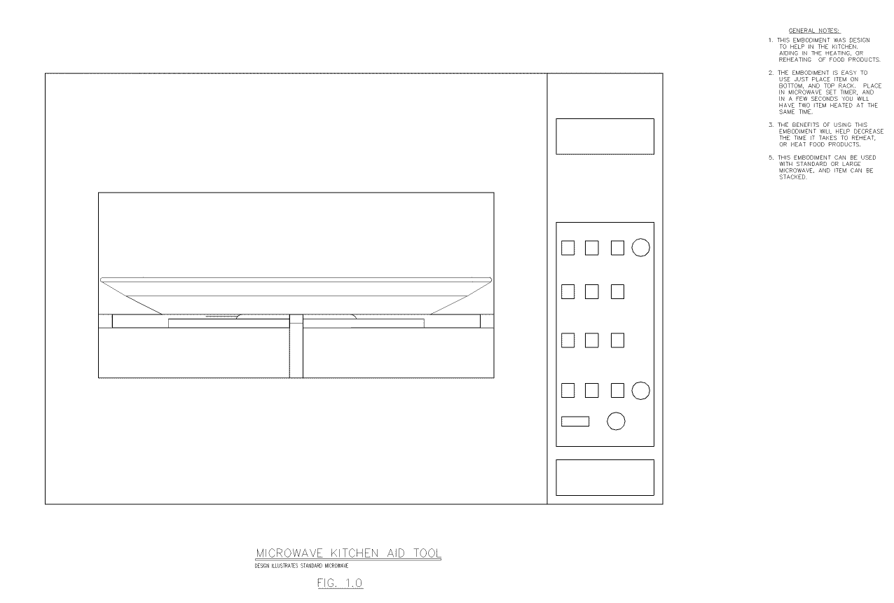

FIG. 1 is a front view of the embodiment inside a standard microwave with general notes. This demonstrate the size of the embodiment inside your standard microwave.

FIG. 2 is a elevation view showing the attachment of the embodiment to ref. 1 by inserting into ref 2. This view demonstrate the way ref. 3 connect to 2 which is a molded part of ref. 1 which is the main unit that rides on your existing microwave turntable.

FIG. 3 is a prospective view of the entire embodiment with all reference parts call out with associated numbers. Here we are showing how the entire embodiment comes together all parts are clearly show with reference numerical number callouts.

FIG. 4 is a elevation view showing the embodiment with two standard kitchen plates stack on the embodiment. In this view we can see how the embodiment stacks to a kitchen plates ref. 8, and is covered by a ref. 10 to protect food splatter in the microwave from building up, and making cleaning the microwave less of a job.

FIG. 5 shows a perspective view of the embodiment with ref. 8, as related to ref. 10. This view shows the embodiment ref. 1 with two kitchen plate ref. 8 and cover ref. 10.

FIG. 6. shows perspective view of embodiment with ref. 8 on both platform inside a standard microwave. This view give you the true perspective of how the embodiment with ref. 8 on top and bottom looks in a standard microwave. This view does not include ref. 10 cover.

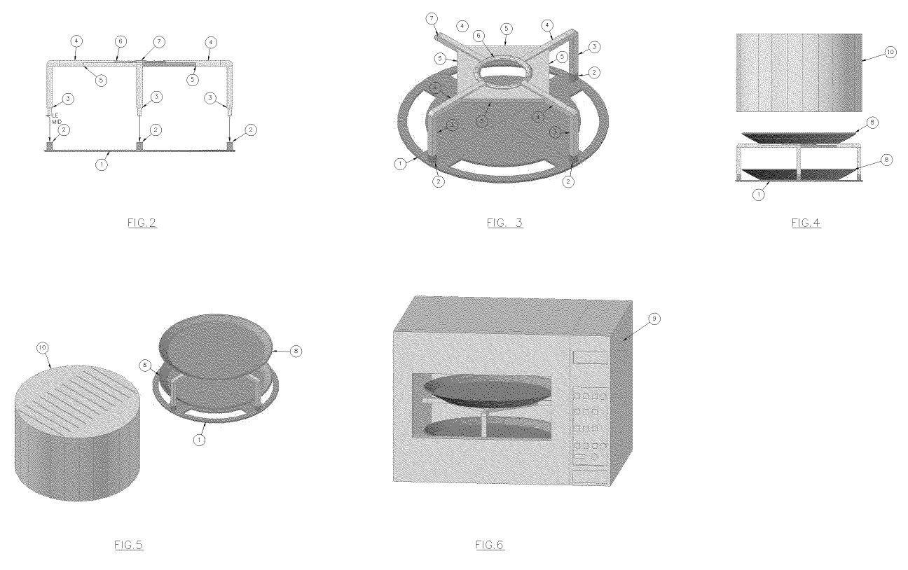

FIG. 7 is a plan view of embodiment ref. 1 with dimension and section call outs. All material are designs to utilize the injection mold process with any approved high temperature thermo dynamic materials. This view shows in detail the main lower embodiment and how it is design to receive the other parts in the assemble.

FIG. 8 is the cross section of embodiment ref. 1 with dimensions. This view shows a clear cross section of the main lower platform, all dimension and callout are detail.

FIG. 9 is elevation view of lower leg ref. 3 with dimension and sections callout this part connect to ref. 2 on the lower end, and ref. 4 on the upper end all structural loads are transfers from the upper platform to the lower platform.

FIG. 10 is cross section of ref. 3 showing dimension and detail callouts. Also showing cutout for better ejection for mold process.

FIG. 11 is a detail for ref. 3 with dimensions. Shows detail dimensions of upper area of ref. 3.

FIG. 12 is detail 2 for embodiment ref. 1 showing dimensions and cross section. This is the critical connection point from ref. 3 to 1 which will insert into female connection and secured with high temperature glue.

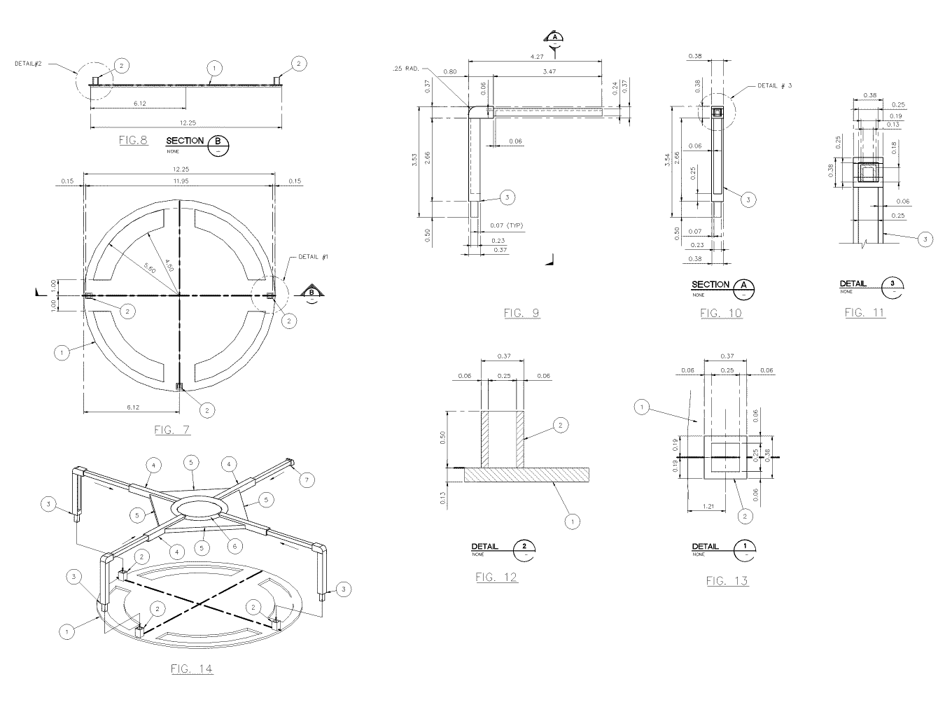

FIG. 13 is detail 1 of embodiment ref. 1 showing dimensions and details. This is a plan view of ref. 2 showing detail of opening for ref. 3 to attach.

FIG. 14 is a assembly of all component and how they connect together. All reference number are shown. This shows the complete assembly and how the connect together all reference number are call out in this view.

FIG. 15 is the main assembly in plan view showing all component and dimension and sectional call outs. In this view we connect ref. 3 and 7 to ref. 4 also ref. 5 is shown for addition support for upper platform.

FIG. 16 is showing a cross section of embodiment ref. 4 and 6 with dimensions. In this view we can see how ref. 3 and 7 are attached to ref 4. This will be a high temperature, or glued bond.

FIG. 17 is ref. 5 showing dimensions. This is the gusset support for strengthening the lateral load on upper platform.

FIG. 18 is a side view of ref. 5. this shows thickness used for ref. 5.

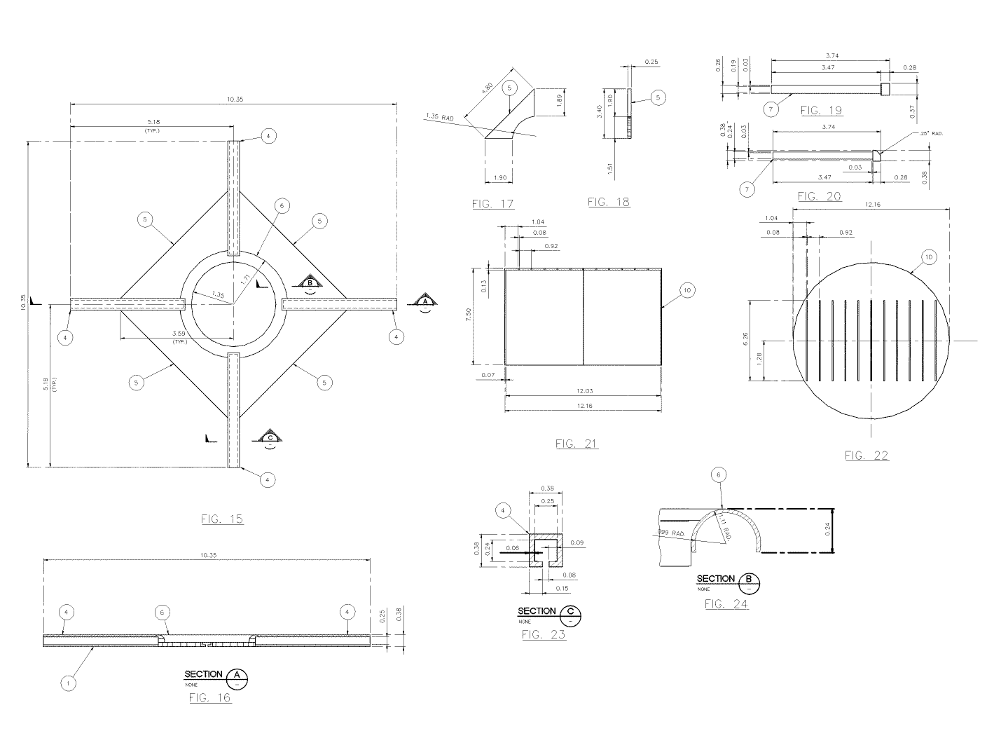

FIG. 19 is a plan view of ref. 7 with dimension. This view shows ref. 7 in plan view showing details.

FIG. 20 show elevation view of ref. 7 with dimensions. This view shows elevation of ref. 7 with details.

FIG. 21 is elevation view of ref. 10 with dimensions. In this view the cover for the embodiment is view in elevation with dimensions.

FIG. 22 shows ref. 10 in plan view with dimensions. The plan view of ref. 10 this view shows the opening design to vent the cover while heating.

FIG. 23 is cross section of ref. 4 with dimensions. This view clearly shows how the structure is design for molding and ease of assemble all thickness are detail.

FIG. 24 is a cross section of ref. 6. This is the heart of the upper platform and was design for strengths and flexibility, and the ease of molding for production runs.

### REFERENCE NUMBERALS

1 main lower platform
2 female socket connection
3 lower leg supports
4 upper main female connections
5 upper main gusset support
6 upper main intersection connection
7 upper arm extension
8 typical kitchen plates
9 standard microwave
10 cover for embodiment

### OPERATION

In operation the insert one must follow common rules for handling food and keeping the unit clean. The following are the best instruction we could come up with to help the average consumer operate our embodiment.

Items can be place on the embodiment on the counter, or in the microwave.

The embodiment can be stored right in the microwave saving storage space.

In the event you have two items that require the same temperature one can be placed on the lower, and one on the upper platform. Always place the heaver of the two items. on the bottom platform.

If the items have different time requirement place the one with the greater requirement on the bottom rack. Keep in mind the weight of the items.

Never!!!! Place any ref. that contain a liquids on the top platform if possible.

Always center the Items. when placing on the top platform lean placement toward the back for more strength. Never!!! place ref. 8 off center toward the front of the upper arm.

Embodiment was design only for reheating, and heating items for no more that 8 minutes. It's not design as a cooker of any type., and never use in a none rotating microwaves.

The high temperature plastic is suitable for microwave and can be clean used normal cleaning method, suggest hand wash.

The maximum weight we are recommending is 10 lb. The embodiment can hold more, but for the normal household we do not expect the weight to exceed 10 lb. We have tested the embodiment up to 19 lb.

The embodiment was design to only have three legs this leaves the front open for easy placement of items on lower platform.

Cover will be a optional accessories use to keep food particles from splashing all over the microwave. This will help keep the microwave clean, and operating longer.

1. High temperature material design for injection molding for all parts used in fabrication.
This material can be any suitable aggregated that will pass all federal state and local standard.
Main body includes: lower platform ref. 1 with three extended leg ref. 3 attached to main upper platform ref. 4 ,5 6, and 7
The three main legs ref. 3 will have a cavity on vertical horizontal and dummy leg.
The front area of the embodiment is open for easy access to place and remove items.
Embodiment was design to rest on a existing microwave tray, or support rollers.
The rotation of your current turntable supply the force to rotate to embodiment
The embodiment will have a cover to protect from splashes of food particles.
